(19) United States
(12) Patent Application Publication
(10) Pub. No.: US 2003/0183328 A1
(43) Pub. Date: Oct. 2, 2003

(54) Method for making a golf club head

(76) Inventor: Hou-Teng Lee, Taipei City (TW)

Correspondence Address: WILDMAN, HARROLD, ALLEN & DIXON, 225 WEST WACKER DRIVE, CHICAGO, IL, 60606, US

(21) Appl. No.: 10/109,303

(22) Filed: Mar. 28, 2002

(51) Int. Cl. B32B 31/00

(52) U.S. Cl. 156/245

(57) ABSTRACT

A method for making a golf club head includes the steps of forming an open head body that includes a face frame and a supporting wall, forming a fiber wall that is integrally connected to and that cooperates with the face frame and the supporting wall to confine an inner space thereamong, and placing a face panel in the face frame and integrally connecting the face panel to an inner face of the face frame.

### CROSS-REFERENCE TO RELATED APPLICATION

This application is related to co-pending U.S. patent application Ser. No. 09/844,319, filed by the applicant on Apr. 27, 2001, the entire disclosure of which is incorporated herein by reference.

### BACKGROUND OF THE INVENTION

1. Field of the Invention

This invention relates to a method for making a golf club head, more particularly to a method for making a golf club head with a composite head body.

2. Description of the Related Art

The method for making a golf club head disclosed in the aforesaid co-pending U.S. patent application Ser. No. 09/844,319 includes the steps of forming an open head body, forming a closed head body by integrally connecting the open head body to a fiber reinforced body, and thermally molding the closed head body with the use of an air bag that is placed in an inner space confined by the closed head body. The open head body is a molded single piece of titanium alloy, and has a face panel portion and a rear wall portion extending from the face panel portion. Although the golf club head is light weight by virtue of the fiber reinforced body, the golf club head is costly, since the open head body of the golf club head is made from titanium alloy to maintain the strength thereof. Moreover, the method is disadvantageous in that removable of the air bag from the inner space in the closed head body after the molding process is inconvenient.

### SUMMARY OF THE INVENTION

Therefore, it is an object of the present invention to provide a method for making a golf club head of a golf club so as to overcome the aforesaid drawbacks as encountered in the aforesaid co-pending U.S. patent application Ser. No. 09/844,319.

Accordingly, a method for making a golf club head of a golf club of this invention comprises the steps of: forming an open head body that includes a face frame of a first metal and a supporting wall of a second metal, the face frame having front and rear sides, defining a frame space, and further having a rear peripheral edge and a looped inner face that confines the frame space, the supporting wall extending rearwardly from the rear peripheral edge of the face frame in a direction transverse to the face frame and having a peripheral edge; forming a fiber wall of a resin-impregnated fiber sheet material that is integrally connected to the rear peripheral edge of the face frame and the peripheral edge of the supporting wall so as to cooperate with the supporting wall and the face frame to confine an inner space thereamong which is in spatial communication with the frame space; and placing a face panel in the frame space, and integrally connecting the face panel to the inner face of the face frame.

### BRIEF DESCRIPTION OF THE DRAWINGS

In drawings which illustrate embodiments of the invention,

FIG. 1 is a perspective view of a golf club head to be made by the method embodying this invention;

FIGS. 2 and 3 are perspective views to illustrate how a supporting wall is integrally connected to a face frame of the golf club head of FIG. 1 according to the method of this invention;

FIGS. 4 and 5 are schematic sectional views to illustrate how a fiber wall of the golf club head of FIG. 1 is formed according to the method of this invention;

FIG. 6 is a schematic sectional view to illustrate how the fiber wall is integrally connected to the assembly of the face frame and the supporting wall via a mold according to the method of this invention;

FIG. 7 is an exploded perspective view to illustrate how the face panel is integrally connected to the assembly of the fiber wall, the face frame, and the supporting wall according to the method of this invention; and

FIGS. 8 to 10 are schematic sectional views to illustrate how the fiber wall is formed and is integrally connected to the assembly of the face frame and the supporting wall according to another method of this invention;

FIG. 11 is a perspective view of another golf club head to be made by the method of this invention;

FIG. 12 is an exploded perspective view to illustrate how a face panel is integrally connected to an assembly of a single piece of a supporting wall and a face frame and a fiber wall according to the method of this invention; and

FIG. 13 is an exploded perspective view to illustrate how the single piece is integrally connected to the face panel according to the method of this invention.

### DETAILED DESCRIPTION OF THE PREFERRED EMBODIMENTS

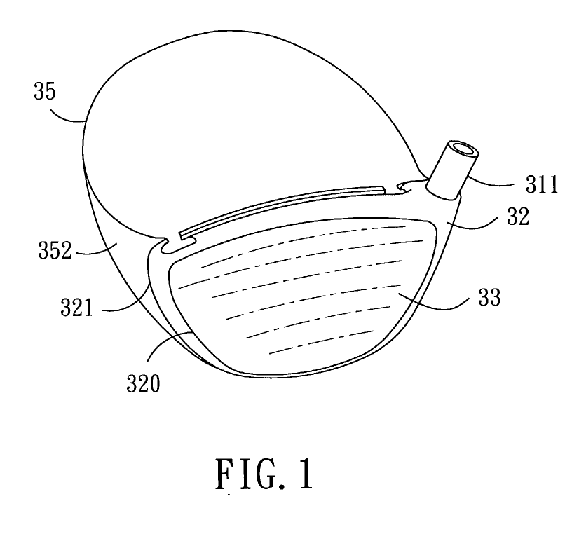

FIGS. 1, 7, and 8 illustrates a golf club head of a golf club to be made by a preferred embodiment of the method of this invention.

The golf club head includes: a face frame 32 having opposite front and rear sides, defining a frame space 320, and further having a looped rear peripheral edge 321 and a looped inner face 322 that confines the frame space 320, the face frame 32 being made from a first metal; a supporting wall 31 extending rearwardly from the face frame 32 in a transverse direction relative to the face frame 32, and having a peripheral edge 315, the supporting wall 31 being made from a second metal; a fiber wall 35 integrally connected to and extending between the peripheral edge 315 of the supporting wall 31 and the rear peripheral edge 321 of the face frame 32, and cooperating with the supporting wall 31 and the face frame 32 to confine an inner space 30 thereamong, the inner space 30 being in spatial communication with the frame space 320, the fiber wall 35 being made from a resin-impregnated fiber sheet material 34; and a face panel 33 received in the frame space 320 and integrally connected to the inner face 322 to cover the frame space 320.

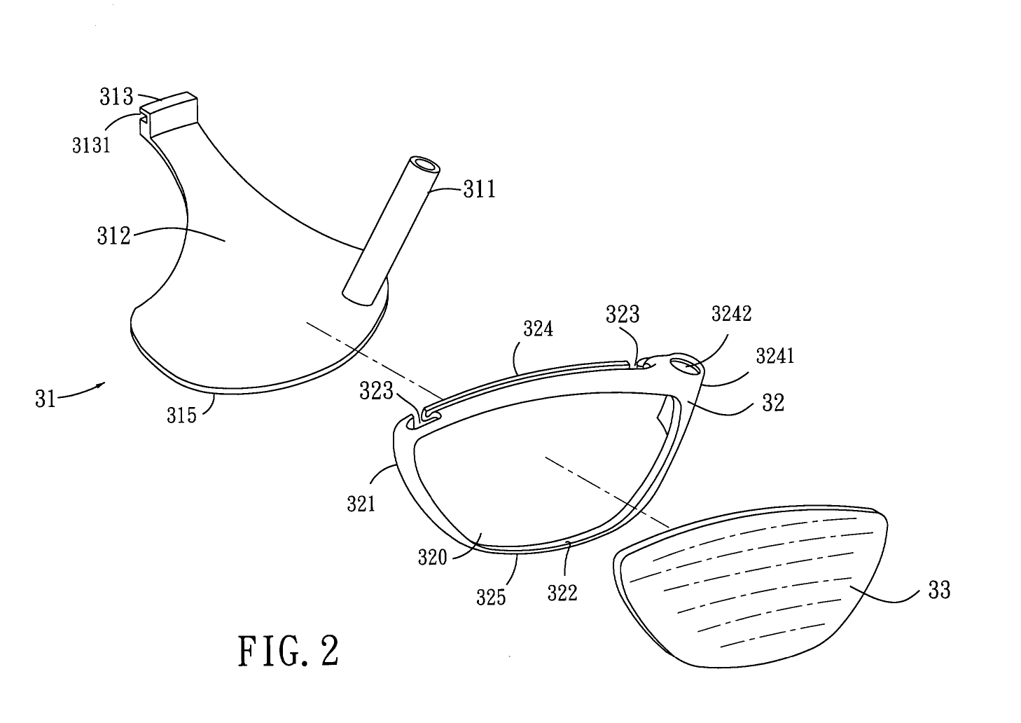

Referring further to FIG. 2, the face frame 32 has opposite top and bottom walls 324, 325. The supporting wall 31 extends rearwardly from the bottom wall 325 of the face frame 32. The top wall 324 of the face frame 32 has a flanged end 3241 which is formed with a rod-receiving hole 3242. The golf club head further includes a shaft-connecting rod 311 that projects upwardly from an upper surface 312 of the supporting wall 31 through the rod-receiving hole 3242 so as to serve as a neck of the golf club head which is to be connected to a shaft of the golf club (not shown).

The top wall 324 of the face frame 32 is formed with two opposing first engaging grooves 323. The supporting wall 31 has a distal end 313 that is distal from the face frame 32 and that is formed with a second engaging groove 3131. The fiber wall 35 is formed with a plurality of engaging tongues 351 that extend into and that engage the first and second engaging grooves 323, 3131, respectively.

Preferably, the first metal is titanium alloy, the second metal is steel, and the bottom wall 325 of the face frame 32 is integrally connected to the supporting wall 31 via known welding techniques. The face panel 33 is preferably made from a resilient metal, such as titanium alloy.

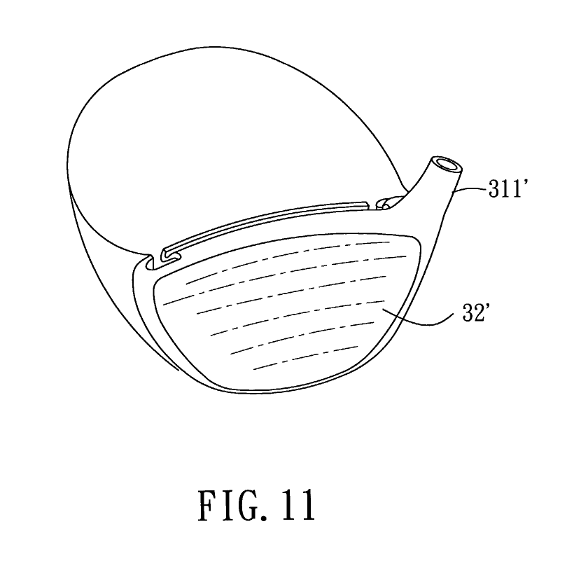

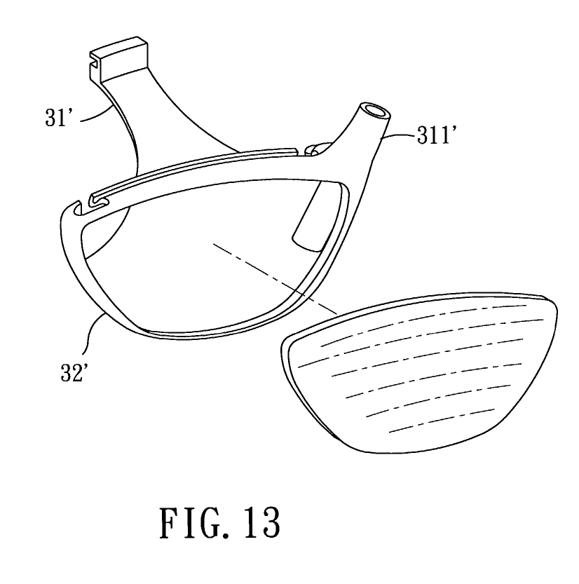

Referring to FIGS. 11 to 13, another golf club head to be made by the method of this invention is shown to have a structure similar to that of FIGS. 1, 7 and 8, except that the face frame 32′, the supporting wall 31′, and the shaft-connecting rod 311′ are formed as a single piece that is made from steel via known molding techniques.

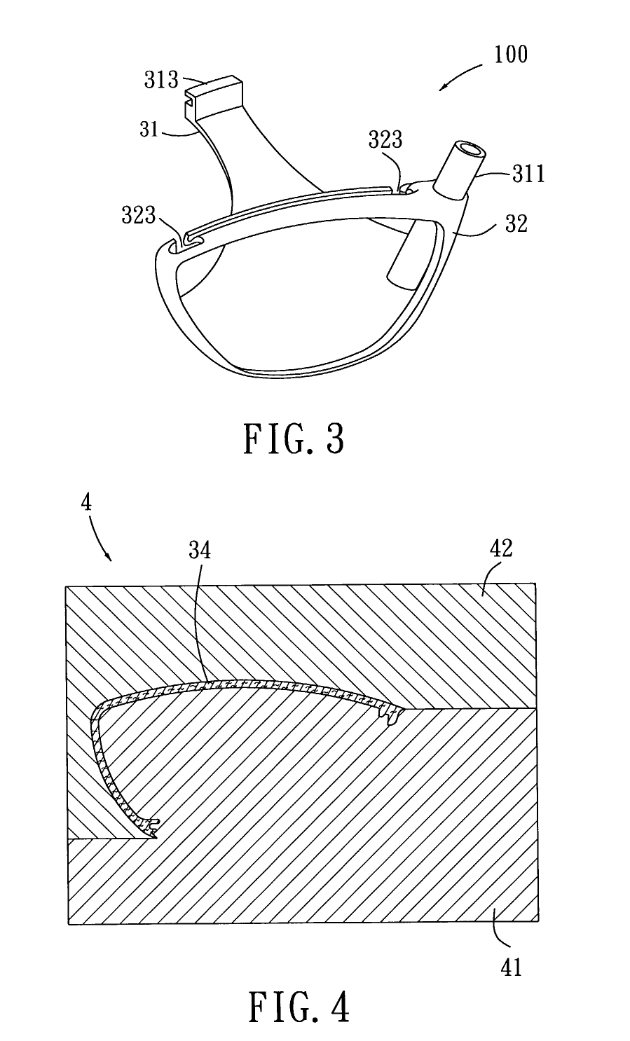

FIGS. 3 to 7 illustrate consecutive steps for forming the golf club head according to a method of this invention.

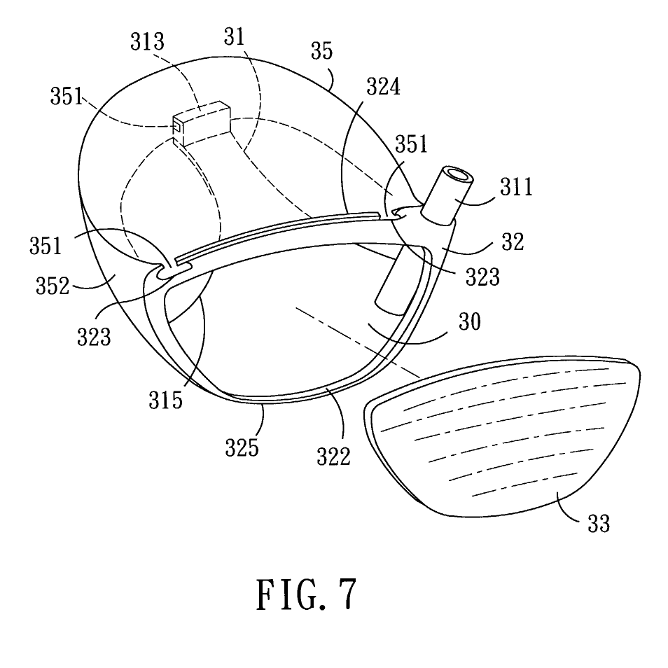

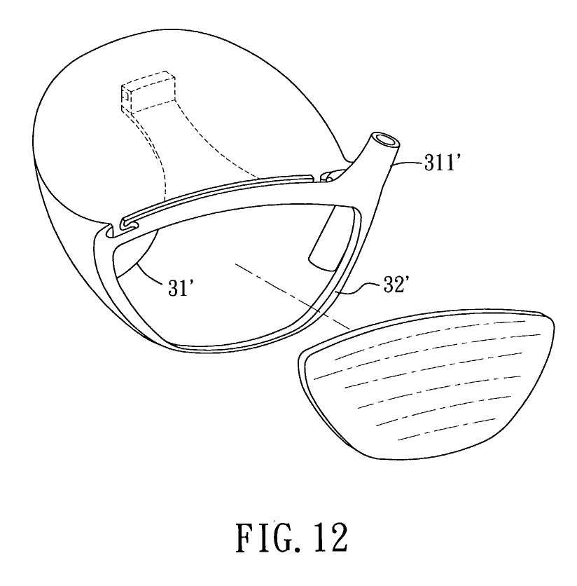

The method includes the steps of: forming an open head body 100 (see FIG. 3) that includes the face frame 32 and the supporting wall 31 which is integrally connected to the face frame 32 by known welding techniques; forming the fiber wall 35 of resin-impregnated fiber sheet material (see FIG. 7) that is integrally connected to the rear peripheral edge 321 of the face frame 32 and the peripheral edge 315 of the supporting wall 31 of the open head body 100 (see FIGS. 7 and 12); placing the face panel 33 in the frame space 320, and integrally connecting the face panel 33 to the inner face 322 of the face frame 32 via known welding techniques (see FIG. 7); and surface finishing the assembly of the face panel 33, the face frame 32, the supporting wall 31, and the fiber wall 35.

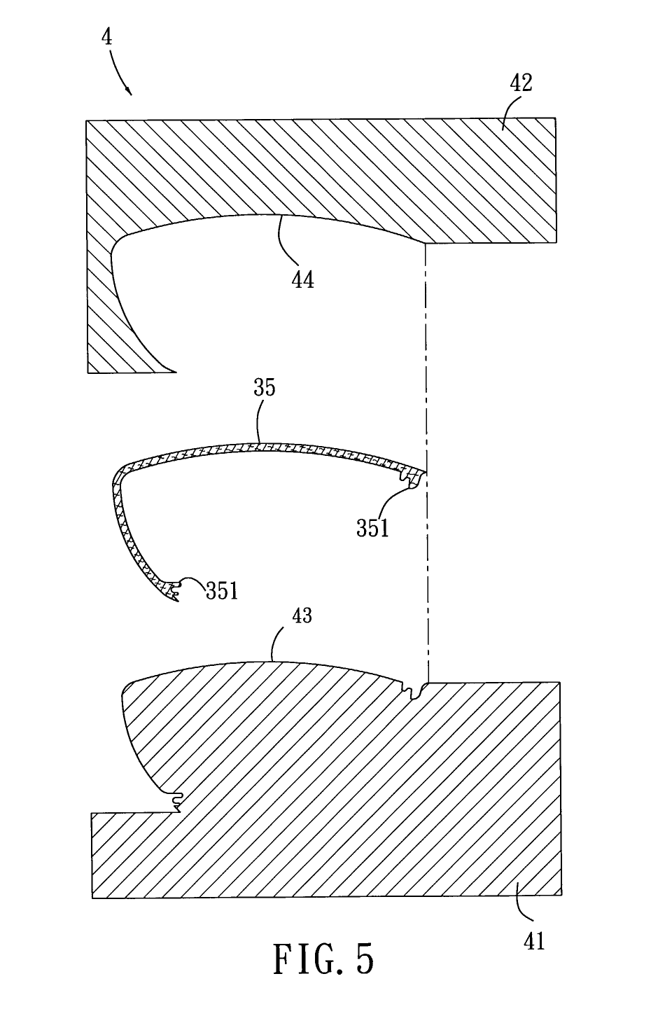

The fiber wall 35 is formed by thermally molding stacked resin-impregnated fiber sheets in a first mold 4 before connecting the fiber wall 35 to the supporting wall 31 and the face frame 32 (see FIGS. 4 and 5). The mold 4 includes a male mold half 41 that defines a convex surface 43, and a female mold half 42 that defines a concave surface 44 which complements to the convex surface 43 of the male mold half 41. The resin-impregnated fiber sheets are stacked on the molding surface of the male mold half 41, and are thermally pressed against the convex and concave surfaces 43, 44 during the molding process. The fiber sheets are preferably carbon fibers. Molding is carried out at a temperature about 130° C. for 30 minutes in order to form the fiber wall 35.

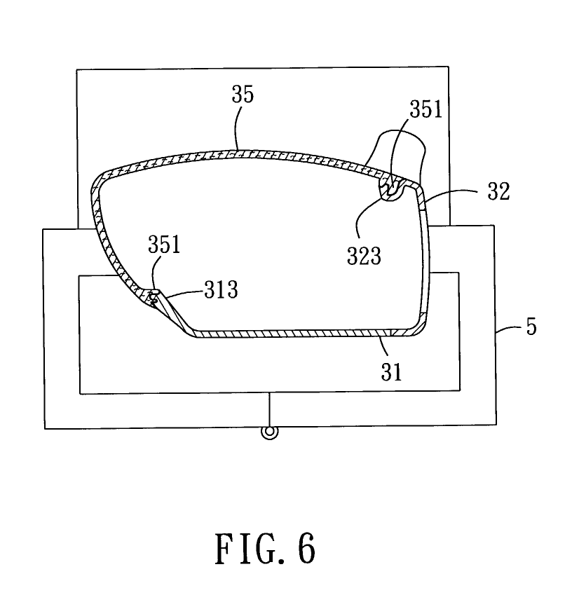

The fiber wall 35 is subsequently integrally connected to the face frame 32 and the supporting wall 31 by applying an adhesive, such as epoxy resin, to the engaging tongues 351 of the fiber wall 35, the engaging grooves 3131 in the supporting wall 31, and the engaging grooves 323 in the face frame 32, and by thermal molding the fiber wall 35, the supporting wall 31, the face frame 32 and the adhesive in a second mold 5 (see FIG. 6). Molding is carried out at a temperature of about 130° C. for 60 minutes in order to connect the fiber wall 35 securely to the open head body 100.

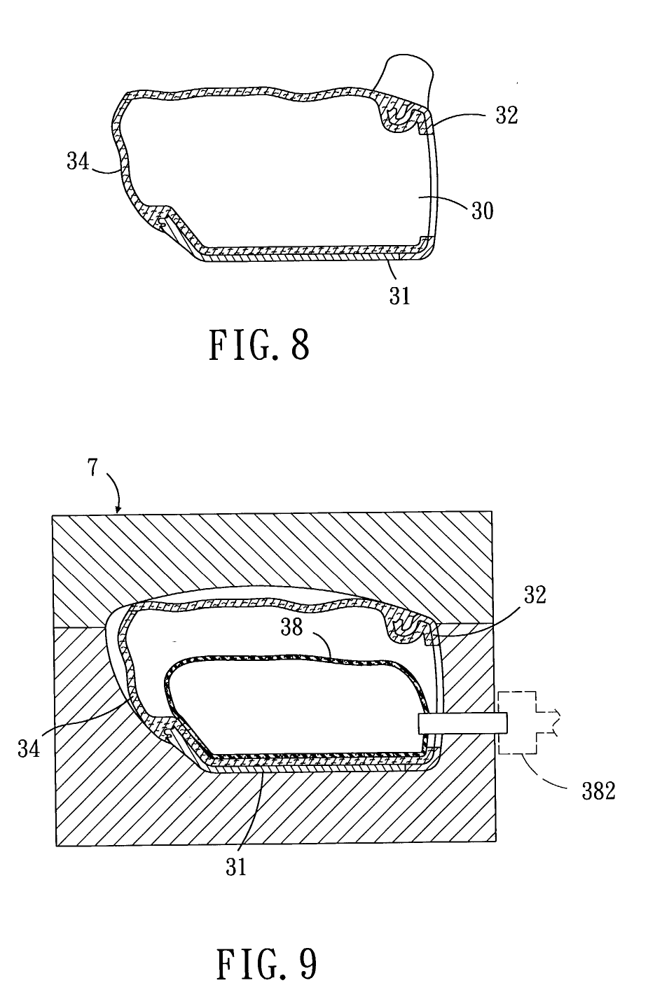

FIGS. 8 to 10 illustrate consecutive steps for forming the first embodiment of the golf club head according to another method of this invention.

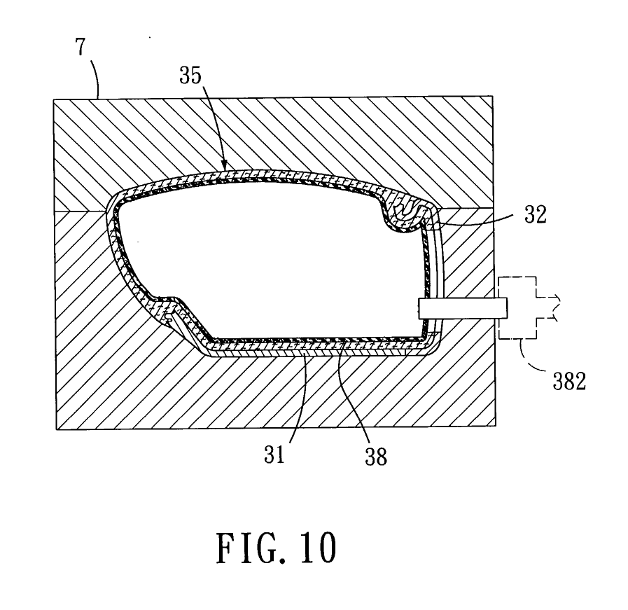

The method is similar to the previous method shown in FIGS. 3 to 7, except that the fiber wall 35 is formed and is integrally connected to the face frame 32 and the supporting wall 31 by connecting the resin-impregnated fiber sheet material 34 to the peripheral edge 315 of the supporting wall 31 and the rear peripheral edge 321 of the face frame 32 (see FIG. 8) to confine the inner space 30, placing an air bag 38 in the inner space 30, placing the assembly of the fiber sheet material 34, the supporting wall 31, the face frame 32 and the air bag 38 in a mold 7 (see FIG. 9), and heating the mold 7 and blowing air into the air bag 38 with the use of a blower device 382 so as to thermally mold and press the fiber sheet material 34 against an inner wall of the mold 7 (see FIG. 10) in order to form the fiber wall 35. After formation of the fiber wall 35, the air bag 38 can be easily accessed and removed from the frame space 320. The air blown into the air bag 38 is pressurized to a range of about 3 to 7 Kg/cm². Molding is carried out at a temperature of about 130° C.

Preferably, the sheet material 34 of the fiber wall 35 includes 4 to 10 resin-impregnated fiber sheets.

With the inclusion of the face frame 32 in the golf club head of this invention, the manufacturing cost of the golf club head can be reduced, and the drawbacks as encountered in the aforesaid co-pending U.S. patent application Ser. No. 09/844,319 can be eliminated.

With the invention thus explained, it is apparent that various modifications and variations can be made without departing from the spirit of the present invention. It is therefore intended that the invention be limited only as recited in the appended claims.

I claim:

1. A method for making a golf club head of a golf club, comprising the steps of:
forming an open head body that includes a face frame of a first metal and a supporting wall of a second metal, said face frame having front and rear sides, defining a frame space, and further having a rear peripheral edge and a looped inner face that confines said frame space, said supporting wall extending rearwardly from said rear peripheral edge of said face frame in a direction transverse to said face frame and having a peripheral edge;
forming a fiber wall of resin-impregnated fiber sheet material that is integrally connected to said rear peripheral edge of said face frame and said peripheral edge of said supporting wall so as to cooperate with said supporting wall and said face frame to confine an inner space thereamong which is in spatial communication with said frame space; and
placing a face panel in said frame space, and integrally connecting said face panel to said inner face of said face frame.

2. The method of claim 1, wherein said fiber wall is formed by thermal molding a plurality of stacked resin-impregnated fiber sheets in a first mold before connecting said fiber wall to said supporting wall and said face frame.

3. The method of claim 2, wherein said fiber wall is integrally connected to said face frame and said supporting wall by applying an adhesive to said fiber wall, said supporting wall, and said face frame, and by thermal molding said fiber wall, said supporting wall, said face frame and said adhesive in a second mold.

4. The method of claim 1, wherein said fiber wall is formed and is integrally connected to said face frame and said supporting wall by connecting said resin-impregnated fiber sheet material to said peripheral edge of said supporting wall and said rear peripheral edge of said face frame to confine said inner space, placing an air bag in said inner space, placing assembly of said fiber sheet material, said supporting wall, said face frame and said air bag in a mold, and heating said mold and blowing air into said air bag so as to thermally mold and press said fiber sheet material against an inner wall of said mold.

5. The method of claim 1, wherein said open head body is formed as a single piece, said first and second metal are steel, and said face panel is made from titanium alloy.

6. The method of claim 1, wherein said supporting wall and said face frame are integrally connected to each other by welding to form said open head body, said first metal is steel, and said second metal is titanium alloy, and said face panel is made from titanium alloy.
